(19) United States
(12) Patent Application Publication
(10) Pub. No.: US 2019/0324409 A1
(43) Pub. Date: Oct. 24, 2019

(54) CLOCK USING BRIGHT DOT DISPLAY

(71) Applicants: WEN-CHIN CHEN, New Taipei City (TW); KUEI-CHUAN HO, Hsinchu City (TW)

(72) Inventor: WEN-CHIN CHEN, New Taipei City (TW)

(21) Appl. No.: 15/959,228

(22) Filed: Apr. 22, 2018

(51) Int. Cl. G04G 9/04; G09G 3/12

(52) U.S. Cl. CPC G04G 9/04; G09G 3/12

(57) ABSTRACT

A clock using bright dot display comprises spaced illuminating display units arranged for the graduation marks of the clock, a micro processing unit which causes the illuminating display units of corresponding graduation marks to illuminate according to the time calculated by a time base unit. Each of the illuminating display units includes a first illuminating state, a second illuminating state and a third illuminating state. The illuminating display unit is the “hour indicator mark” in its first illuminating state, the “minute indicator mark” in its second illuminating state, and both the “hour indicator mark” and “minute indicator mark” in its third illuminating state. A user may easily read the time by observing the on and off states of the illumination of the “hour indicator mark” and “minute indicator mark” as well as the illumination colors of the illuminating display units.

### BACKGROUND OF THE INVENTION

### 1. Field of the Invention

The present invention relates to a clock using bright dot display and particularly to a clock using bright dot display which indicates time using easily readable indicator marks without making noises like a conventional analog clock with moving hands.

### 2. Description of Related Art

There are two types of conventional clocks, the analog clock and the digital clock. The analog clock typically comprises a main body, an hour hand and a minute hand, wherein time is indicated using graduation marks on the main body. This type of clock has the following disadvantages:

1. Its need to be framed restricts its aesthetic design.

2. As its hands are driven by a mechanism, the movement of the hands makes noises, which may be particularly loud at quiet night.

3. Lighting is needed when one needs to check the time at night.

The digital clock, on the other hand, displays time on a display panel. Although the digital clock does not have the foregoing disadvantages of the analog clock, it is still hard to improve the aesthetic design of its numeric representation.

Further, the functions of the variety of clocks are mostly limited to displaying time and providing decoration with its aesthetic design. Some variations may provide such additional functions as temperature detection and moisture detection without making any alteration to the conventional way of displaying time. They are monotonous and lackluster. Further, clocks may be disposed on some outdoor billboards or shop signs, but again these clocks are monotonous and lackluster. In view of this, after laborious research and experiments, the applicant has devised a clock using easily readable bright dot display.

### SUMMARY OF THE INVENTION

It is a primary objective of the present invention to provide a clock using bright dot display which indicates time using easily readable indicator marks and which may be beautiful and eye-catching so as to break the monotony of clock design.

A foregoing clock using bright dot display comprises spaced illuminating display units arranged for the graduation marks of the clock, a micro processing unit which causes the illuminating display units of corresponding graduation marks to illuminate according to the time calculated by a time base unit. Each of the illuminating display units includes a first illuminating state, a second illuminating state and a third illuminating state. The illuminating display unit is the “hour indicator mark” in its first illuminating state, the “minute indicator mark” in its second illuminating state, and both the “hour indicator mark” and “minute indicator mark” in its third illuminating state. A user may easily read the time by observing the on and off states of the illumination of the “hour indicator mark” and “minute indicator mark” as well as the illumination colors of the illuminating display units.

The foregoing clock using bright dot display, wherein the illuminating display units are mono-color, bi-color or multi-color LEDs for displaying the first illuminating state, the second illuminating state and the third illuminating state.

The foregoing clock using bright dot display, wherein in an interior of the clock is disposed a control circuit comprising at least a micro processing unit, a time base unit and a driving unit. The control circuit is connected to the illuminating display units for driving them to display the first illuminating state, the second illuminating state and the third illuminating state.

The foregoing clock using bright dot display, wherein the LEDs are soldered on a circular circuit board connected to the control circuit.

The foregoing clock using bright dot display, wherein at least an advertising area is disposed on a panel body for printing and arranging various kinds of advertising designs and texts thereon. On a periphery of the advertising area are spaced illuminating display units circularly arranged for the graduation marks of the clock to form a clock using bright dot display with an advertising function.

The foregoing clock using bright dot display, wherein on a base body may be disposed a standing sign thereon are spaced illuminating display units arranged for the graduation marks of the clock to form a clock using bright dot display with a decorating function.

### BRIEF DESCRIPTION OF THE DRAWINGS

FIG. 1 is a three-dimensional view of the present invention;

FIG. 2 is a structural drawing of the present invention;

FIG. 3 is a block diagram of a circuit according to a preferred embodiment of the present invention;

FIG. 4 is a drawing of the present invention in operation;

FIG. 5 and FIG. 6 are three-dimensional views of the present invention used for advertising; and

FIG. 7 is a three-dimensional view of the present invention used for decoration.

### DETAILED DESCRIPTION OF THE PREFERRED EMBODIMENTS

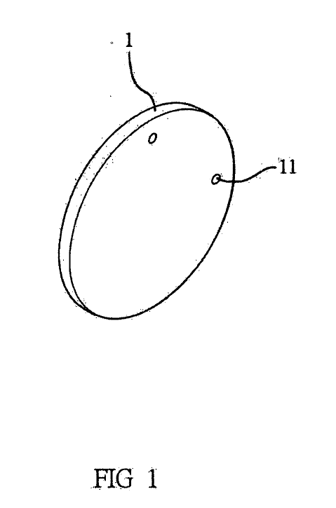

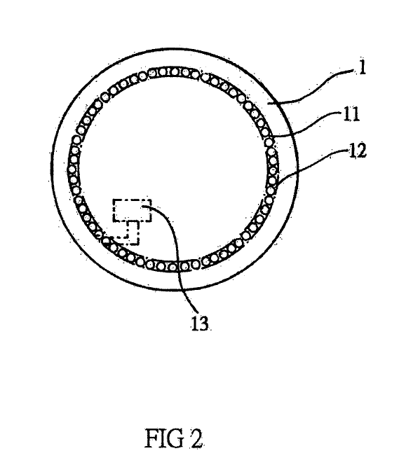

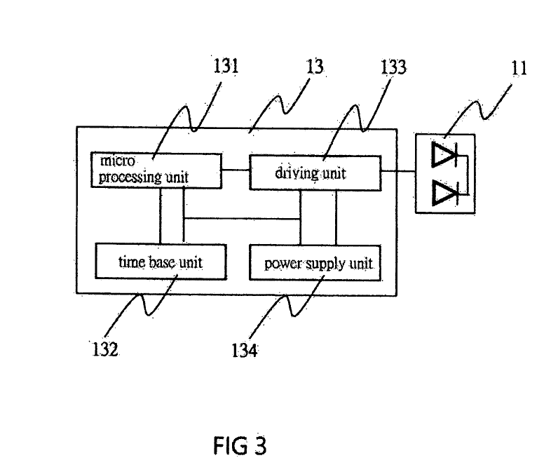

Please refer to FIG. 1 and FIG. 2 as well as FIG. 3, showing respectively a three-dimensional view and a structural drawing of the present invention, and a block diagram of a circuit according to a preferred embodiment of the present invention. As the figures show, the present invention comprises spaced illuminating display units 11 arranged for the graduation marks on a main body 1 of the clock. Each of the illuminating display units 11 includes a first illuminating state, a second illuminating state and a third illuminating state, and the illuminating display units 11 are spaced according to the graduations of the clock. In this preferred embodiment, there are 60 illuminating display units 11 for the “hours” and the “minutes.” The illuminating display unit 11 is the “hour indicator mark” in its first illuminating state, the “minute indicator mark” in its second illuminating state, and both the “hour indicator mark” and “minute indicator mark” in its third illuminating state. In this preferred embodiment, the illuminating display units 11 are mono-color, bi-color or multi-color LEDs. These mono-color, bi-color or multi-color LEDs are soldered on a circular circuit board 12 and display a first illuminating state and a second illuminating state. These illuminating display units 11 may of course be light bulbs or other illuminating elements for displaying a first illuminating state, a second illuminating state and a third illuminating state.

In an interior of the main body 1 of the clock is disposed a control circuit 13, which is connected to the foregoing circular circuit board 12. In this preferred embodiment, the control circuit 13 includes at least a micro processing unit 131, a time base unit 132 and a driving unit 133 connected to the micro processing unit 131, and a power supply unit 134 for providing power to the entire control circuit 13. The time base unit 132 provides the calculated time to the micro processing unit 131, which then controls via the driving unit 133 corresponding illuminating display units 11 (mono-color, bi-color or multi-color LEDs) to display a first illuminating state, a second illuminating state and a third illuminating state of different colors. The illuminating display unit 11 is the “hour indicator mark” in its first illuminating state, for example, red illumination. The illuminating display unit 11 is the “minute indicator mark” in its second illuminating state, for example, green illumination. And the illuminating display unit 11 is both the “hour indicator mark” and “minute indicator mark” in its third illuminating state, for example, cyan illumination.

A combination of the foregoing elements forms a clock using bright dot display. The control circuit 13 drives the illuminating display units 11 to display a first illuminating state, a second illuminating state and a third illuminating state. A user may easily read the time by observing the on and off states of the illumination of the “hour indicator mark” indicated by the first illuminating state and the “minute indicator mark” indicated by the second illuminating state, as well as the simultaneous on state of the “hour indicator mark” and “minute indicator mark” indicated by the third illuminating state.

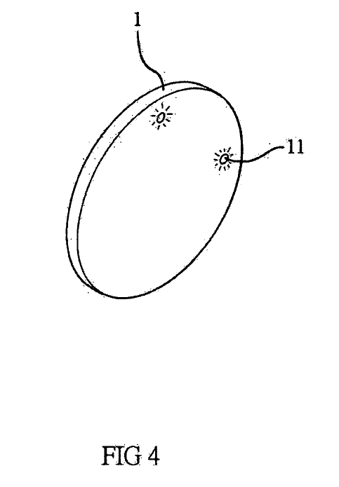

Please refer to FIG. 4, showing a drawing of the present invention in operation. Please also refer to FIG. 3. As the figures show, the present invention displays the time calculated by the time base unit 132 by controlling corresponding illuminating display units 11 via the micro processing unit 131 and the driving unit 133. For example, when the time is 1:15, the illuminating display unit 11 on the one-hour position will display red illumination (the first illumination state), and the illuminating display unit 11 on the fifteen-minute position will display green illumination (the second illumination state).

Another example is: when the time is 1:05, the illuminating display unit 11 on the one-hour position will display both the first and the second illumination states and turn into the third illumination state. In the foregoing preferred embodiment, the first and the second illumination states will be mixed and turn into cyan illumination, the third illumination state. In this manner, when an illuminating display unit needs to display two illumination states, the colors of the two illumination states will be mixed and turn into a third color, creating interesting color changes when displaying time. The overlapped illumination state may of course be presented in other manners: for example, the “hour indicator mark” in its first illuminating state may display steady red illumination, whereas the “minute indicator mark” in its third illuminating state may display blinking green illumination.

In comparison with the conventional analog clock with moving hands, the clock using bright dot display according to the present invention has at least the following advantages:

1. The present invention displays time only on the frame without using moving hands and numerical indicator marks, which may enhance the aesthetic beauty of the design.

2. Without the conventional moving hands, the present invention does not make noises and works silently.

3. The hour and the minute are displayed by illumination of different colors, so time may be directly displayed and be easily readable even at night without additional lighting.

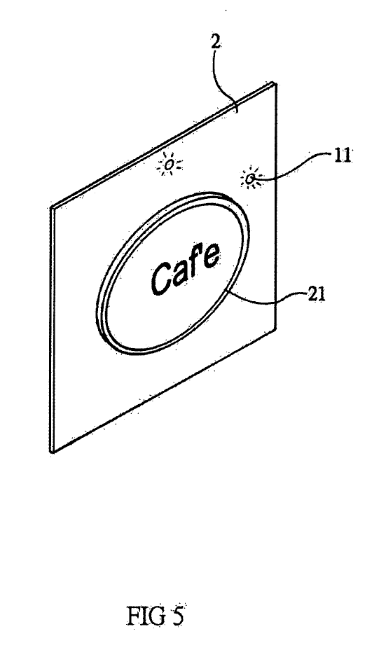

Please refer to FIG. 5, showing a three-dimensional view of the present invention used for advertising. Please also refer to FIG. 3. As the figures show, at least an advertising area 21 is disposed on a panel body 2 of the present invention for printing and arranging various kinds of advertising designs and texts thereon. On a periphery of the advertising area 21 are spaced illuminating display units 11 circularly arranged for the spaced graduation marks of the clock to form a clock using bright dot display with an advertising function. The illuminating display units 11 may display a first illuminating state, a second illuminating state and a third illuminating state, and the control circuit 13 drives the illuminating display units 11 to display a first illuminating state, a second illuminating state and a third illuminating state. A user may easily read the time by observing the on and off states of the illumination of the “hour indicator mark” indicated by the first illuminating state and the “minute indicator mark” indicated by the second illuminating state, as well as the simultaneous on state of the “hour indicator mark” and “minute indicator mark” indicated by the third illuminating state. A clock using bright dot display according to the present invention may effectively display time and advertise at the same time in an eye-catching manner, breaking the monotony of clock design.

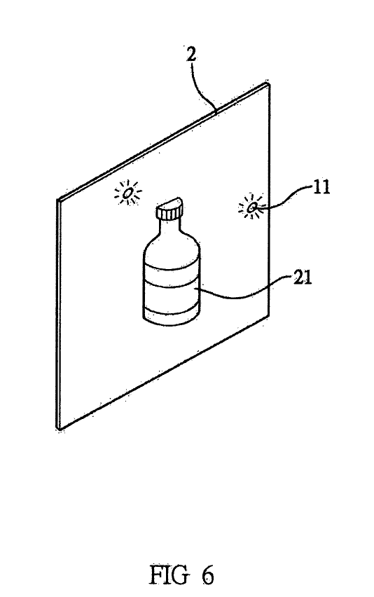

As FIG. 6 shows, in the advertising area 21 arranged on the panel body 2 may be disposed various kinds of advertising designs. In this preferred embodiment, a soda-water advertisement may be disposed. An eye-catching clock using bright dot display with an advertising function is formed by placing in the advertising area 21 a bottle of soda-water in relief with illuminating display units 11 arranged on the periphery.

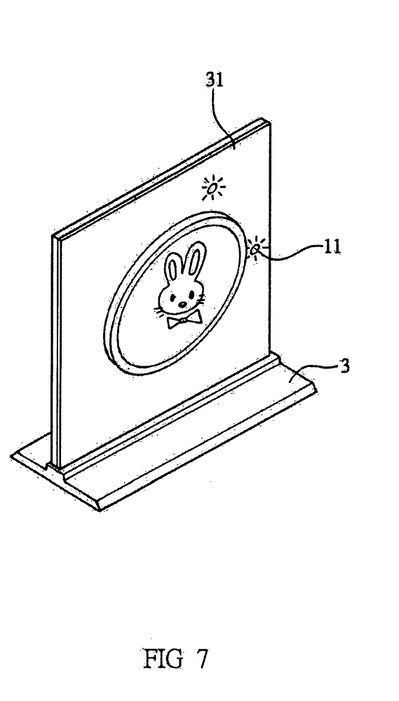

Please refer to FIG. 7, showing a three-dimensional view of the present invention used for decoration. As the figure shows, a clock using bright dot display of the present invention may provide a decorating function. In this preferred embodiment, a standing sign 31 is disposed on a base body 3. On the standing sign 31 are spaced illuminating display units 11 arranged for the graduation marks of a clock. Each of the illuminating display units includes a first illuminating state, a second illuminating state and a third illuminating state. The illuminating display unit is the “hour indicator mark” in its first illuminating state, the “minute indicator mark” in its second illuminating state, and both the “hour indicator mark” and “minute indicator mark” in its third illuminating state. A user may easily read the time by observing the on and off states of the illumination of the “hour indicator mark” and “minute indicator mark” as well as the illumination colors of the illuminating display units. Further, the base body 3 and standing sign 31 may form a beautiful decoration to be placed anywhere in the house, providing a decorating function besides its practical function of displaying time.

The foregoing preferred embodiments of the present invention are illustrated of the present invention rather than limiting of the present invention. It is intended to cover various modifications and changes included within the spirit and scope of the appended claims, the scope of which should be accorded the broadest interpretation so as to encompass all such modifications and similar structures.

In view of the foregoing, the present invention comprises spaced illuminating display units arranged for the graduation marks of the clock. Each of the illuminating display units is the “hour indicator mark” in its first illuminating state, the “minute indicator mark” in its second illuminating state, and both the “hour indicator mark” and “minute indicator mark” in its third illuminating state. A user may easily read the time by observing the on and off states of the illumination of the “hour indicator mark” and “minute indicator mark” as well as the illumination colors of the illuminating display units.

What is claimed is:

1. A clock using bright dot display comprising spaced illuminating display units arranged for the graduation marks of the clock; wherein each of the illuminating display units includes a first illuminating state, a second illuminating state and a third illuminating state; wherein the illuminating display unit is the “hour indicator mark” in its first illuminating state, the “minute indicator mark” in its second illuminating state, and both the “hour indicator mark” and “minute indicator mark” in its third illuminating state; and wherein a user may easily read the time by observing the on and off states of the illumination of the “hour indicator mark” and “minute indicator mark” as well as the illumination colors of the illuminating display units.

2. A clock using bright dot display of claim 1, wherein in an interior of the clock is disposed a control circuit comprising at least a micro processing unit, a time base unit and a driving unit, with the control circuit connected to the illuminating display units for driving the illuminating display units of corresponding graduation marks to display the first illuminating state, the second illuminating state and the third illuminating state in different colors.

3. A clock using bright dot display of claim 1, wherein the illuminating display units are mono-color LEDs for displaying the first and the second illuminating states.

4. A clock using bright dot display of claim 1, wherein the illuminating display units are bi-color or multi-color LEDs for displaying the third illuminating state.

5. A clock using bright dot display of claim 1, wherein the illuminating display units may be light bulbs or other illuminating elements.

6. A clock using bright dot display of claim 1, wherein the illuminating display units are soldered on a circular circuit board connected to the control circuit.
